(19) United States
(12) Patent Application Publication
(10) Pub. No.: US 2014/0039912 A1
(43) Pub. Date: Feb. 6, 2014

(54) Controlled Communications Mobile Digital System for Physician-Healthcare System Integration

(71) Applicant: Navio Health, LLC, Newark, NJ (US)

(72) Inventors: Adam Turinas, Chatham, NJ (US); Stuart M. Hochron, Jersey City, NJ (US)

(73) Assignee: Navio Health, LLC, Newark, NJ (US)

(21) Appl. No.: 13/955,139

(22) Filed: Jul. 31, 2013

Related U.S. Application Data
(60) Provisional application No. 61/677,845, filed on Jul. 31, 2012.

(51) Int. Cl. G06F 19/00

(52) U.S. Cl. CPC G06F 19/322
USPC 705/2

(57) ABSTRACT

An integrated digital mobile communications management system having HIPAA compliant text, email, and image capability that complies with medical record maintenance requirements and facilitates physician/provider utilization of a healthcare system's resources is presented. The mobile platform capabilities include selection of physician/providers based on specialty, practice interests and medical insurance plan participation, the scheduling of physician/provider referrals and medical procedures, various bilateral communications between healthcare providers and healthcare systems, reporting of physician/provider location, and provision of medical information and delivering news and alerts. The management system includes a mobile digital smart-device App that verifies users, encrypts and decrypts electronic messages, and transmits and receives electronic messages. Encrypted messages are securely stored, and automatically incorporated into patients' healthcare records. The App provides a mobile digital communication management platform that integrates messaging capabilities with a hospital scheduling system to facilitate quick and easy scheduling of medical procedures and physician/provider consultations.

### CLAIM OF PRIORITY

This application claims the priority of U.S. Ser. No. 61/677,845 filed on Jul. 31, 2012. This application is copending with U.S. Utility patent application Ser. No. 13/913,951 filed on Jun. 10, 2013, the contents of both applications are fully incorporated herein by reference.

### FIELD OF THE INVENTION

The invention relates to a controlled, integrated digital communications platform or management system, and more particularly to a digital communications management system incorporating mobile devices, secure encryption and secure storage that satisfy both State and Federal regulations and guidelines for secure maintenance and transmission of protected patient health information.

### BACKGROUND OF THE INVENTION

Healthcare has seen an explosion of software technologies devoted to improving the delivery of healthcare services. However, most of these technologies are one off systems designed to improve a single aspect of healthcare services, for example, the creation and delivery of Electronic Healthcare Records (or EHR's) or text messages among medical providers.

While various software inventions address certain specific aspects of the delivery of healthcare system communications, few if any provide methods that give the major stakeholders of a “healthcare system” a controlled communication management system that can be utilized across the broad spectrum of the separate but related entities of a particular healthcare system. A “healthcare system” is a collection of entities including, but not limited to the organization of people, institutions, and resources needed to deliver healthcare-related services to meet the healthcare needs of target patient populations. In one preferred embodiment the healthcare system is the organization of people, institutions, and resources associated with a particular hospital. In another embodiment, the healthcare system is the organization of people, institutions, and resources associated with a group of two or more hospitals, or an insurance organization or group of two or more insurance organizations. Other types of organizations that deliver healthcare-related services may also qualify as a healthcare systems, the primary component being a group of physicians, nurses and/or other healthcare providers and/or their offices and staff needing coordinated communication, scheduling and/or referral services. Examples of these other types of organizations include Health Maintenance Organizations (HMOs), Accountable Care Organizations (ACOs), Group Medical Practices, Surgi-Centers, and Management Service Organizations (MSOs). The latter is an example of a business that utilizes coordinated communications with hospitals systems, physicians and staff to manage medical offices and other healthcare facilities.

Thus, the present invention describes communications and management tools which may be used within a particular entity, but may also be used by stakeholders of a healthcare system (usually the hospital management or administration). It provides the stakeholders with tools to communicate not only across the hospital but also with the many separate entities that make up a “healthcare system”. The present invention is unique in that it provides an easily downloadable mobile App through which all participants in one or more “healthcare systems” may receive and exchange communications that are HIPPA compliant, even though the participants are associated with different organizations that make up the healthcare system. This allows these participants to engage in communications, patient referrals, scheduling, delivery of data, and other services to interact among themselves as further described below, regardless of which group or organization within the healthcare system they may be affiliated.

Medical practitioners, physician groups, physician's offices, hospital systems, Health Maintenance Organizations (HMOs), Accountable Care Organizations (ACOs), Community Health centers, Health Insurance Exchanges (HIEs) and institutions that provide healthcare-related services would like to utilize the ease and speed of modern digital mobile communication devices and techniques such as, but not limited to, the mobile digital texting and/or email capabilities of digital mobile smartphones and tablets. The integration of these entities with their healthcare providers and staff through mobile technology would provide a more user-friendly management system to the entities. However, health professionals must ensure that any communications containing a patient's protected health information (PHI) is exchanged in a secure manner that complies with all relevant US Federal regulations, including the regulations mandated by the US Health Insurance Portability and Accountability Act (HIPAA). HIPAA compliance is stringent and requires, for instance, that any PHI, i.e., any information regarding the health status, the provision of healthcare, or the payment for healthcare that can be linked to a specific individual, must be maintained in a secure and accountable manner at all times. As conventional smartphone texting and emailing typically involves data being transferred through one or more unsecure servers in an un-encrypted form, conventional smartphone texting and emailing is not HIPAA compliant.

In addition to being HIPAA compliant, information exchanged between physicians and other healthcare professionals and healthcare systems regarding a patient's treatment is typically regarded as PHI, is part of the patient's medical record, and as such is typically required by State law or health provider regulations to be stored in a manner that conforms to standards of, for instance, data integrity and authentication. This includes practices such as, but not limited to, locking entries to protect data from accidental or unauthorized alteration and the validation of the correctness of all information including the identities of all parties involved including the patient, the physician/providers and the time and date of any communication.

In addition to these compliance concerns, healthcare providing institutions and systems have a vested interest in attempting to integrate with physician/providers, their offices and staff, and an extended network of ancillary healthcare-related personnel to form a reliable management system. Presently, healthcare providing institutions, such as hospitals, employ management methodologies that are fragmented and marked by a lack of synchronous communications and ease of access. An ideal management system for such healthcare providing institutions and their systems may allow for a much more streamlined and simple data sharing facility and network. This, in turn, facilitates: a) incoming referrals for medical procedures, b) physician/provider consultation from physician/providers within their hospital system, HMO, ACO, or other healthcare system's network of physician/providers, c) minimizing the number of referrals leaving their network of in-system physician/providers to physician/providers outside of the healthcare system provider-network and d) delivering physician practice parameters (metrics that include length of hospital stay, compliance with up-to-date practice standards, outcome comparisons with peers, etc.) to physicians and healthcare practitioners, e) coordinate centralized “on-call” lists for all departments and services of a healthcare system, f) coordinated centralized “patient lists” for teams of healthcare providers, g) delivering patient data and consultation requests from hospitals or healthcare systems or medical offices' “electronic medical record” (EMR) systems directly to practitioners' mobile devices, h) coordinating patient care. These objectives may be met by having a mobile, digital communications system methodology that incorporates easy access to, and easy scheduling with, physician/providers within a healthcare network of a healthcare system (i.e. hospital).

The present invention accomplishes all of these communications requirements, as discussed in more detail below.

### DESCRIPTION OF THE RELATED ART

US Patent Application 20090254971 submitted by F. Hers et al. on Oct. 8, 2009 entitled “Secure Data Interchange” that describes a secure data interchange system which enables information about bilateral and multilateral interactions between multiple persistent parties to be exchanged and leveraged within an environment that uses a combination of techniques to control access to information, release of information, and matching of information back to parties. Access to data records can be controlled using an associated price rule. A data owner can specify a price for different types and amounts of information access.

US Patent Application 20060282395 submitted by J. Leibowitz on Dec. 14, 2006 entitled “Methods for using a mobile communications device in consumer, medical and law enforcement transactions” that describes a system and methods to integrate, secure and simplify transaction conducted by means of a mobile electronic communications device such as a cell phone or smartphone, combining biometric identification, computer software applications resident in the device's memory, PAN (personal area network) and data storage and transmission means, such system and methods being useful in credit or debit card transactions, automated transmission and retrieval of private medical information and the retrieval of law enforcement data, among other possible uses, purposes and applications.

US Patent Application 20060195342 submitted by M. Khan et al. on Aug. 31, 2006 entitled “Method and system for providing medical healthcare services” that describes a method for ordering over a network one or more tests for a medical condition for a patient, the method including the steps of providing to the user over the network one or more tests for the patient that can be selected, allowing a user to select over the network one or more tests, determining whether a constraint exists on ordering any of the selected tests; ordering the selected tests over the network, obtaining a result of each of the ordered tests, and providing an automated evaluation based upon feedback resulting from the ordered tests. Using the methods and systems described, a user, such as a physician/provider, can easily obtain information over a network about a large number of tests and order any of the tests over the network. The server can also obtain payment and related information from the user at the time the one or more tests are ordered.

US Patent Application 20110191122 submitted by O. Kharraz-Tavakol et al. on Aug. 4, 2011 entitled “Method and Apparatus for Managing Physician Referrals” that describes a method and apparatus for managing the physician referral process, whereby a referring physician (e.g., a primary care provider) refers a patient to another physician (e.g., a specialist) for a particular medical procedure, analysis or care. An aggregator provides systems and methods available to physicians and their administrative staff (herein collectively referred to as physicians or doctors) to: book appointments on behalf of their patients online through a doctor directory and calendar function; filter available doctors by specialty, subspecialty, procedure, insurance participation and/or hospital network; transfer a patient's personal information, medical history and pre-selected insurance forms from one doctor's office to another's, electronically; transfer and upload relevant forms and paperwork via fax from one doctor's office to another; track referrals historically (over time) on a by-doctor or by-patient basis; facilitate referrals to and from doctors in a certain network or group.

Various other implementations are known in the art, but also fail to address all of the problems solved by the invention entitled “Controlled Communications Mobile Digital System for Physician-Healthcare System Integration,” that is described herein. One embodiment of the present invention is illustrated in the accompanying drawings and will be described in more detail herein below.

### SUMMARY OF THE INVENTION

The present invention concerns a controlled, integrated mobile digital communications management system that may be used by a Physician office, Group medical practice, Hospital(s), Surgi-center, MSO, ACO, HMO, HIE and any healthcare system to provide HIPAA compliant text, image, and/or email communications between practitioners, patients, nursing staff, office staff, healthcare personnel and administrators, while complying with electronic medical record maintenance requirements and also facilitating physician/providers utilization of a set of services and physician/providers associated with the healthcare system.

As used herein the term “healthcare system” is the organization of people, institutions, and resources to deliver healthcare-related services to meet the healthcare needs of target patient populations. In one preferred embodiment the healthcare system is the organization of people, institutions, and resources associated with a particular hospital In another embodiment, the healthcare system is the organization of people, institutions, and resources associated with a group of two or more hospitals, or an insurance organization or group of two or more insurance organizations. Other types of organizations that deliver healthcare-related services may also qualify as a healthcare systems, the primary component being a group of physicians, nurses and/or other healthcare providers and/or their offices and administrative and other staff needing coordinated communication, scheduling and/or referral services. Examples of these other types of organizations include Health Maintenance Organizations (HMOs), Accountable Care Organizations (ACOs), Group Medical Practices, Surgi-Centers, and Management Service Organizations (MSOs). The latter is an example of a business that utilizes coordinated communications with physicians and staff to manage medical offices and other healthcare facilities.

In a preferred embodiment, the controlled, integrated mobile digital communications management system of the present invention may also provide a mobile digital platform for the tracking of physician/provider location within a healthcare system, delivering patient data from staff or directly from an electronic medical record system, consultation information, news and urgent alerts to physician/providers and other hospital and/or office personnel, for delivering and managing “on-call” schedules for departments and services, for managing meeting calendars and coordinating patient lists among providers, and for delivering practice performance parameter data to physicians and other providers.

In a preferred embodiment, the controlled digital mobile communications management system may include mobile smart-device Apps that may be machine executable instructions that enable a mobile smart-device to perform various functions.

The functions the mobile smart-device may perform may include, but are not limited to, functions such as verifying that a user is an authorized user of the mobile smart-device, and then securely encrypting any electronic message that may contain information related to a patient. The messages may be any electronic messages such as, but not limited to, text messages, emails, images or some combination thereof. The mobile smart-device may then transmit the electronic message to an identified recipient, and may receive an electronic confirmation that the message has been received.

In a preferred embodiment, the electronic message may then be tagged with any necessary identification information such as, but not limited to, the user's identity, the patient's identity, the recipient's identity and the confirmation of receipt. The tagged message may then become a permanent part of a patient's electronic medical record, and be stored in a secure digital storage unit that may be operated and accessed by the healthcare system.

In a preferred embodiment, the mobile App may also enable the smart device to receive and decrypt incoming messages, and automatically transmit confirmations of receipt when the messages are read. The App may also automatically cause the tagged electronic message to be incorporated into the patient's healthcare record. The App may provide an integrated mobile digital communication management platform that integrates the messaging capabilities with a healthcare institution's patient medical record ordering and procedure scheduling systems in order to facilitate quick and easy scheduling of medical procedures and physician/provider consultations. It may also send mobile notification of consults or a patient's hospital admission directly from an EMR system to physician/providers involved in a patient's care.

The controlled, integrated mobile digital communications management system may be used for any medically-related communication purpose such as, but not limited to, the referral of a patient from one physician/provider to another physician/provider, the scheduling of procedures, and communications between and among healthcare providers and among healthcare providers and healthcare institutions, the delivery of physician practice parameter metrics, providing actions that a physician/provider can take to improve his/her practice parameter metrics, the delivery of patient data from a healthcare institution's EMR system, the coordination of on-call physician lists, patient lists and calendars, and the delivery of continuing medical education information. By having an easily accessible database of in-system physician/providers indexed by factors such as their specialty, their names, the geographic location of their office(s), and the insurance plans they accept, the controlled, integrated digital mobile communications system may facilitate patient referrals to in-system physician/providers.

The controlled digital mobile communications management system of this invention may further help a healthcare provider manage his/her PHI information security by allowing the App to receive instructions from a central controller that may lock the mobile smart-device and thereby prevent stolen or lost devices being used by unauthorized users.

The mobile App, as described above, is readily distinguishable from present non-mobile desktop interfaces. The mobile App operates cross mobile platforms (iPhone, iPad, android smartphones and tablets) giving individuals the ability to use the platform most advantageous to the individual for their type of position within the healthcare system. Most desktops, laptops, etc. have Wi-Fi access, but a small percentage have 3G or 4G capabilities. Having acces to 3G and 4G transmissions gives the App superiority when it comes to connectivity and guaranteed access to the data required. The App additionally has a more streamlined graphical user interface (GUI) than their computer-based counterparts. By removing most of the functionality foreign to all but seasoned computer users the App readily allows anyone to quickly navigate from one area to another in a small, self-contained package saving precious time.

Therefore, the present invention succeeds in conferring the following, and others not mentioned, desirable and useful benefits and objectives.

It is an object of the present invention to provide HIPAA compliant texting, image transfer and emailing thereby coordinating all medical providers with their peers, nurses, their office staff, their healthcare system network, and any healthcare institutions, persons or healthcare related businesses that deliver healthcare-related services.

It is another object of the present invention to provide a means for healthcare systems and any healthcare-related entity to facilitate physician/provider's use of the services of the healthcare system and its in-system physicians and services.

It is another object of the present invention to provide a means for healthcare systems and any healthcare-related entity to provide up-to-date “on-call” schedules for physician services, healthcare system calendars, and lists of patients for particular management teams. It is another object of the present invention to provide a means for healthcare systems and any healthcare-related entity to deliver to physicians/providers, in a secure, mobile digital format, patient data (in the form of text or images) and consultation request information.

Yet another object of the present invention is to provide a secure, automated means of updating electronic patient health record information with communications between and among physician/providers and nurses and/or other personnel.

A further objective of the system is to provide healthcare providers with a secure, HIPAA compliant platform for discussing patient-related healthcare matters using secure electronic communications including texting, images and email.

A further objective of the system is to provide hospitals, physicians, physician's office staff, hospitals and healthcare institutions with a web-based version of the App that will connect them to all functions of the App, and to all users of the App.

It is an object of the present invention to provide a healthcare system digital communication management system that is readily customizable to the healthcare system and to the individual user.

### BRIEF DESCRIPTION OF THE DRAWINGS

FIG. 1 shows a schematic overview of the controlled communications system of the present invention.

FIG. 2 shows a further schematic overview of the controlled communications management system of the present invention.

FIG. 3 shows a flow diagram of representative steps of the functioning of the controlled communications management system of the present invention.

FIG. 4 is a flow chart showing the support system of the controlled communications management system of the present invention.

FIG. 5 is a flow chart showing the interrelationship between the administration implementing the controlled communications management system of the present invention.

FIG. 6 is a flow chart showing the news sharing capabilities of the controlled communications management system of the present invention.

FIG. 7 is a flow chart showing the emergency alert system of a controlled communications management system of the present invention.

FIG. 8 is a flow chart illustrating the consultation process for referrals in a controlled communications management system of the present invention.

FIG. 9 is a flow chart illustrating the implementation of secure messaging in a controlled communications management system of the present invention.

FIG. 10 is a flow chart showing the concierge service progression in a controlled communications management system of the present invention.

FIG. 11 is a flow chart showing the survey process in a controlled communications management system of the present invention.

FIG. 12 is a flow chart showing the survey feedback in a controlled communications management system of the present invention.

### DESCRIPTION OF THE PREFERRED EMBODIMENTS

The preferred embodiments of the present invention will now be described with reference to the drawings. Identical elements in the various figures are identified with the same reference numerals.

Various embodiments of the present invention are described in detail. Such embodiments are provided by way of explanation of the present invention, which is not intended to be limited thereto. In fact, those of ordinary skill in the art may appreciate upon reading the present specification and viewing the present drawings that various modifications and variations can be made thereto.

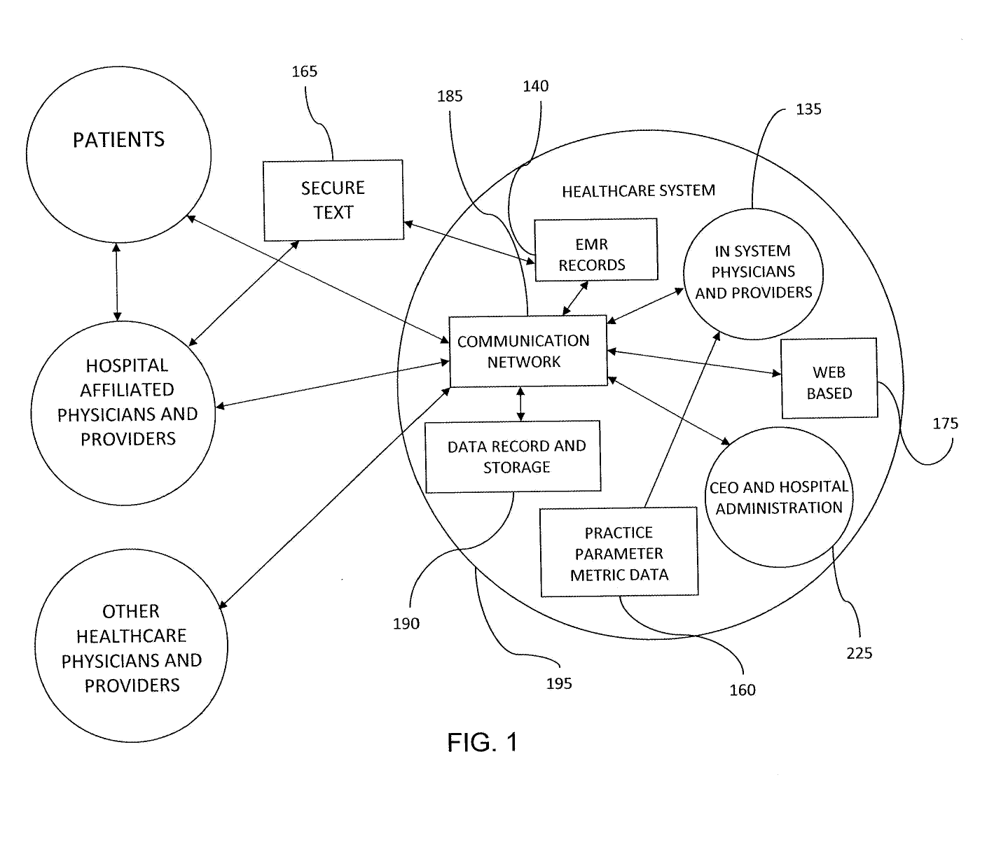

FIG. 1 shows a schematic overview of the controlled communications management system of the present invention. The overall goal is to provide a particular methodology to manage a system of hospital staff and their associated network.

The controlled, mobile integrated digital communications management system may include a central controller 185 that provides secure HIPAA compliant communication between a variety of authorized users 120, who may constitute a healthcare system, and an identified recipient 135 such as, but not limited to, one or more healthcare system employed physician/providers, patients, the CEO and the healthcare institution administration staff, non-employed affiliated physician/providers and other healthcare providers. The management system provides for the delivery of practice parameter metric data 160 to the in-system physician/providers 135. By having a readily available dashboard with metric readouts, the physicians/providers 135 can have a visual representation in real time of factors such as infection rates or patient satisfaction amongst many others. This metric data 160 can be tied to training videos, blogs, exercises, or the like to help seek out, identify, and rectify problem areas.

In a preferred embodiment, the controlled, integrated digital communications management system may also provide authorized users with access to a secure digital storage unit 190 that may, for instance, be used to securely store electronic patient medical records 140, personnel information and general medical information. This information may be communicated via text or other wireless means through a secure communication 165. The information contained in these records is highly confidential and as such the secure communication includes at least a 256 bit encryption and employs an SSL if using an Internet based communication means.

The healthcare system 195 may, for instance, be a hospital, a group of hospitals, a physician group practice, an HIE, an HMO, an ACO, a Community Health Center, an insurance company or any institution or any combination of the aforementioned institution(s) that delivers healthcare-related services that include a collection of physicians/providers and other healthcare practitioners (or some combination thereof) that may all be affiliated in a healthcare delivery system.

The controlled communications system 100 may, for instance, provide mobile digital electronic messaging 125 capabilities between the members of the healthcare system 195 and their affiliates in a secure, encrypted and controlled manner, at least as described above, so that all the communications, including text messages, email messages and images, are both HIPAA compliant and meet all relevant standards for the care of protected health information (PHI).

The term physician/provider may, for instance, include any State or Federal licensed medical practitioner such as, but not limited to, Medical Doctors (MD), Doctors of Osteopathy (DO), Dentists (DDS & DMD), and practitioners of Complementary and Alternative Medicine (CAM) such as, but not limited to, primary care physicians and specialty physician/practitioners such as, but not limited to, cardiologists, pulmonologists, nephrologists, neurologists, endocrinologists, gastroenterologists, dermatologists, general surgeons, ENT surgeons, cardio-thoracic surgeons, vascular surgeons, ophthalmologists, obstetricians, colorectal surgeons, dentists, oral surgeons, orthopedists, neurosurgeons, podiatrists, psychiatrists, chiropractors, acupuncturists and others, or any combination(s) thereof.

The term physician/provider may also, for instance, include medical practitioners not having MD, DO, DDS, DMD or DPM licenses such as, but not limited to, dentists, optometrists, pharmacists, respiratory therapists, occupational therapists, nurses, physician extenders, nurse practitioners, physician assistants and others, or any combination(s) thereof.

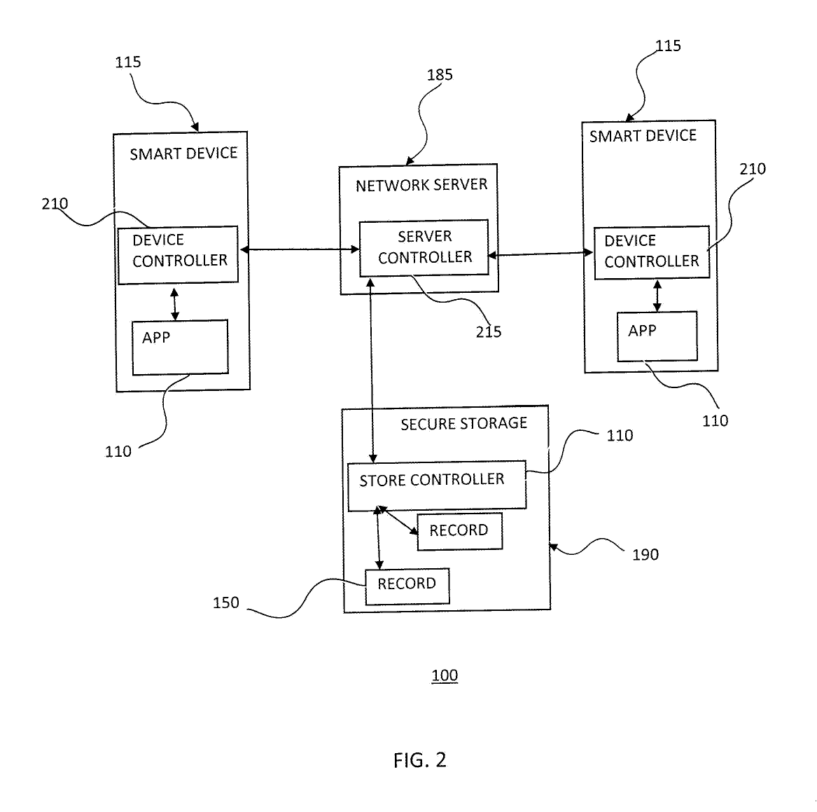

FIG. 2 shows a further schematic overview of the controlled communications management system of the present invention.

In a preferred embodiment, the controlled, integrated digital communications management system 100 may include one or more digital mobile smart-devices 115, a central controller 185 and a secure digital storage unit 190.

The mobile digital smart-device 115 may, for instance, be any suitable digital communications device such as, but not limited to, a mobile phone, a smart phone, a tablet, a computer, a landline or some combination thereof. The mobile smart-device 115 may, for instance, have a device controller module 210 that may be a combination of hardware and software that is configured to provide digital communication capability such as, but not limited to, voice, voice-mail, email, texting, images, video or some combination thereof.

An application, or App, may be configured to operate on the mobile smart-device 115 and may include machine executable instructions 110 designed to enable the mobile smart-device to perform a variety of functions. The App may be fully customizable to the specific healthcare system and/or user. This would enable the user to make changes to menus, graphics, icons, and options that are tailored to their particular needs. These functions may include operations such as, but not limited to, identifying any user attempting to use the device, securely encrypting any electronic messages regarding a patient having a patient identity prior to transmitting messages to an identified recipient, receiving an electronic confirmation of receipt from the recipient, or the recipient's mobile smart-device, tagging the message with information that may include a user identity, a patient identity and the electronic confirmation of receipt, causing the tagged electronic message to be stored in a secure digital storage unit that may be operated by the healthcare system, receiving and decrypting an encrypted electronic message, transmitting an electronic confirmation of the receipt of a message or other communication, or some combination thereof.

The communications to and from the mobile smart-devices 115 may be mediated by a suitable central controller 185 that may include a server controller module 215 that may be software, hardware or a combination thereof.

The central controller 185 and its associated operation instructions modules may, for instance, monitor any messages transmitted or received by any of the mobile smart-devices 115 associated with the controlled, integrated digital communications system 100. This monitoring may, for instance, take the form of monitoring one or more encrypted messages and/or monitoring any meta-data associated with the one or more messages. As a result of such monitoring, the central controller 185 may automatically associate the message with a designated record set that may be associated with an identified patient, an identified user or a function related database or some combination thereof. The results of such actions may be designed to make the controlled, integrated mobile digital communications management system HIPAA compliant, and may include the storing of a designated record sets 150 on a secure digital storage unit 190 by means of a store controller that may include suitable machine executable instructions 110.

Alternatively, it is equally important that those who do not have a smart device 115 readily accessible can still access the network server 185 securely and reliably. Many nurses make use of “computers on wheels” (COWs). These may or may not have wireless capabilities but are vital to the daily operations in hospitals and medical offices. Patient information can be entered and accessed through COWs or other “workstations on wheels”. Often, the COWs are equipped with EMR and DSS systems and can perform a variety of functions including showing lab tests results and connecting to diagnostic and non-diagnostic equipment. In this system, referrals can also be sent out on the fly creating further interconnections within the management system. Using this system with a COW works in accordance with the description above; the means of accessing the system is slightly different.

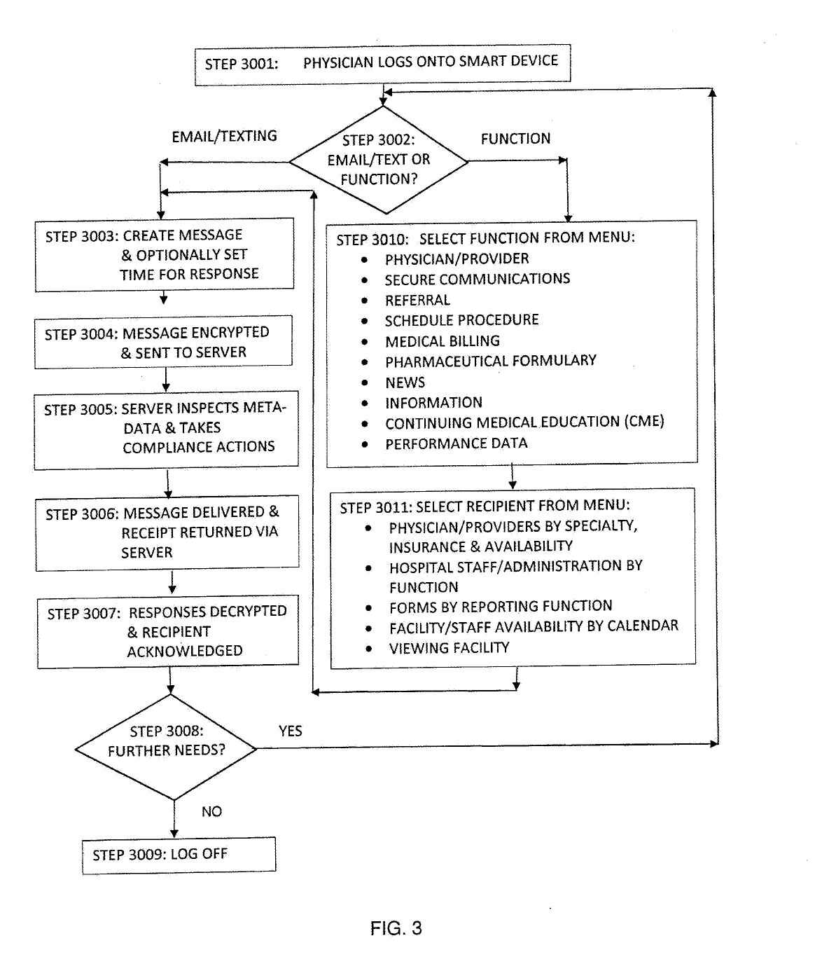

FIG. 3 shows a flow diagram of representative steps of the functioning of the controlled communications management system of the present invention.

In step 3001: “Physician/User logs onto smart device”, a user may be required by the App running on the mobile digital smart-device 115 to identify himself/herself as a bona-fide authorized user of the controlled, integrated digital mobile communications management system. This authorization may, for instance, use a standard challenge response approach that may be a username/password/PIN combination, or it may involve biometric information such as, but not limited to, a fingerprint, a retina scan, an image or some combination thereof.

In step 3002, “Email/text or function?” the authorized user may now select whether to user the mobile smart-device 115 merely as a communications device by selecting email/texting, or to access one of the many other functions supported by the controlled, integrated digital communications management system 100.

In step 3003: “Create message and optionally set time for response”, the user may create a message using a real or virtual keyboard, a menu of pre-prepared messages, a voice recognition system, a secure camera function that encrypts images, or some combination thereof. In a preferred embodiment, the user may also have the option to enter a “time for a response”, i.e., a specific period of time that may be allowed to elapse from the transmission of the message to the opening of the message by recipient, before the sender is notified that the message has not been opened, and/or a “time for delivery”, i.e., a specific time during the next 24 hours when the transmission of the message will take place.

In step 3004: “Message encrypted and sent to server” the App may encrypt the message and/or image(s) using any suitable encryption method, but preferably a public key encryption systems such as, but not limited to, the well-known RSA encryption system. Once encrypted the message may be sent to the central controller 185 in a digital form using any suitable transmission method such as, but not limited to, wireless transmission, fixed line transmission, optical or co-axial fiber transmission, satellite transmission or some combination thereof.

In step 3005: “Server inspects message meta-data and takes any necessary compliance actions” the central controller 185 may monitor the incoming message by examining the encrypted message, by decrypting the message and examining the text of the message, by examining the meta-data or any tagged information associated with the message, or some combination thereof.

Based on examination of the message, the central controller 185 may take appropriate action such as, but not limited to, storing a copy of the message in encrypted or unencrypted form, or a combination thereof, on a secure digital storage unit 190, updating an appropriate database with information gained from the message or some combination thereof. A storage controller that may include a suitable set of machine executable instructions 110, may facilitate storage of the copies of the message. The storage of the data may, for instance, be in the form of a designated record set 150 that may be HIPAA compliant and/or compliant with any relevant corporate, state or federal laws or regulations, or some combination thereof.

In step 3006: “Message delivered and receipt returned to sender via server”; the server may now forward a copy of the message to the intended recipient or recipient(s). The server may also send a notification back to the sender confirming that the message has been received by the server and transmitted on to the intended recipient(s). The recipient(s), which may include a healthcare system's electronic medical record system, may send a similar notice of receipt-of-message back to the server and/or the sender when the message is accessed on the recipient's mobile smart-device 115.

In step 3007: “Any incoming responses decrypted and recipient altered”, the App operable on the user's mobile digital smart-device 115 may accept any incoming messages, such as, but not limited to, responses to outgoing messages and notices of receipt, or some combination thereof. Incoming messages may be decrypted in full or in part, and may be displayed to the user in either fully or partially encrypted form. The App may also automatically transmit acknowledgements of receipt back to the server and/or the sender that the message has been received.

In step 3008 “Further needs?” the user may elect to end their use of the controlled, integrated digital communications management system and proceed to step 3009 “Log off”. In this step the user may, for instance, exit from the system app and proceed to use the mobile smart-device in an unregulated manner.

If, in step 3008, the user elects to use the controlled, integrated digital communications management system for further functions or communications, they may then loop back to step 3002 “Email/text or function?”

If they now elect to use a function of the controlled, integrated digital communications management system 100, they may proceed to Step 3010: “Select function from a menu that may include: Consults, Secure Text, Schedule Procedure, News or Information, On-Call, Calendars, Patient Lists, Continuing Medical Education and Performance Data, or some combination thereof.

These functions may, for instance, include the ability to request and/or order physician and provider consultation, order patient medication and other forms of therapy and to request, order or schedule patient procedures. Other functions may, for instance, include communicating performance data on a regular basis to physicians and other providers, providing Continuing Medical Education (CME) in the form of video and other formats to physicians and other providers, providing on-call lists for departments and/or services, providing patient lists for teams of physicians/providers and connecting physicians and other providers to other medically-related entities, including medically-related business entities such as a medical malpractice insurance entity.

Once one of the function options is selected, the user may then proceed to step 3011 to access appropriate databases of information or resources.

For instance, if in step 3011 “Select intended recipient from menu that may include: physician/providers by specialty, insurance & availability, hospital staff/administration by function, forms by reporting function, facility/staff availability by calendar”.

If the user elects either a “Consults”, “Secure Text” or a “Schedule Procedure” function, they may first be presented with a search field through which strings of letters access a database of physician/providers by categories such as, but not limited to, their specialty, the medical insurance coverage they participate in, their practice special interests or their availability or some combination thereof.

The user, or referring physician/provider, may then make a suitable selection, i.e., they may have a patient requiring a specific type of specialty care and who is eligible for a certain medical insurance plan and prefers to access care within a certain geographic location, and use the database to select an available in-system physician/provider who meets these criteria. The referring physician/provider may then send this information, by way of the App after inputting a patient's email address, to both the referring physician, his/her medical office, and to the patient so the patient may make an appropriate and convenient appointment. The referring physician/provider may, instead, send the information only to the referral physician/provider and/or his/her office, or their staff, so that they may make the appointment using databases available via the central controller 185 and send, or cause, that information to be sent to the patient. The referring physician/provider may, instead, select a further option in which they, or their staff, make the appointment for the patient using databases available via the central controller 185 and themselves send, or cause that information to be sent to the patient.

The user may also select the recipient to be a viewing facility, i.e., a device to receive, record and/or display data or video. The viewing facility may, for instance, be a Healthcare System's EMR system or a device such as, but not limited to, a specific video monitor, a specific video projector, a specific mobile display device or some combination thereof.

Accessing the databases, or sending information to patients may, for instance, be done by looping back to step 3003 “Create message and optionally set time for response” and follow the flow chart from there. In this manner an encrypted electronic message that is a referral of an identified patient, or an appointment for a procedure, may be sent by an authorized user of the controlled, integrated mobile digital communications management system to a healthcare system operated facility, a recognized specialist, or some combination thereof.

As before, accessing the databases, or sending information to administrators, may, for instance, be done by looping back to step 3003 “Create message and optionally set time for response and/or delivery” and follow the flow chart from there. In this manner an encrypted electronic messages may access and provide the required functionality.

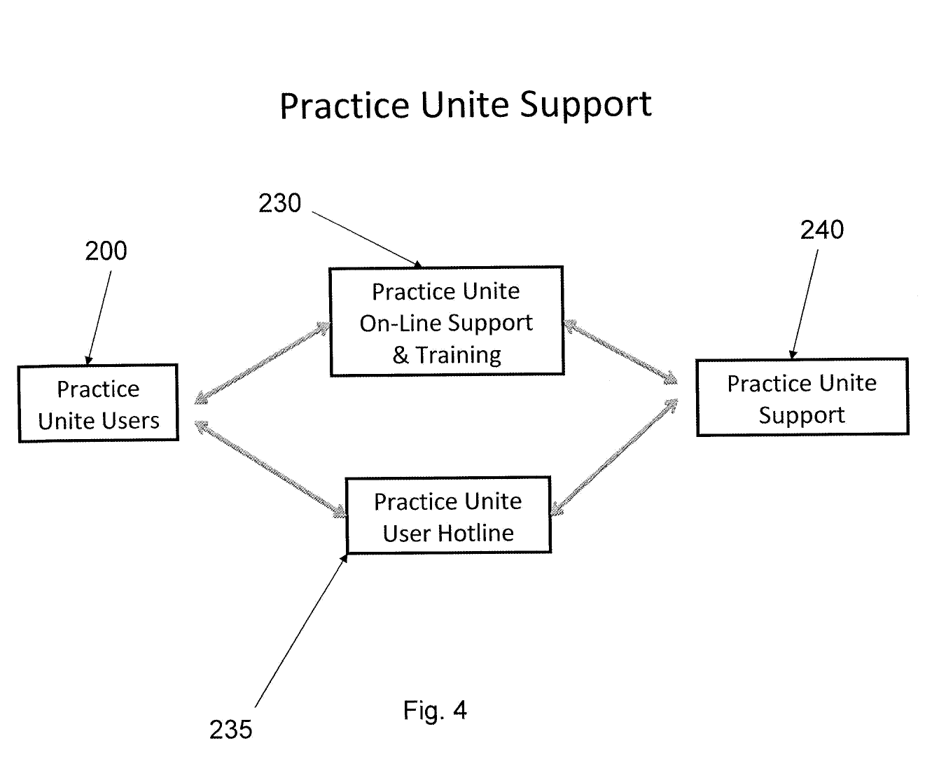

FIG. 4 demonstrates the App support system. The App users 200 are linked to the App support 240 through at several different means. The App users 200 can access support through the App user hotline 235. In order to access the hotline one must be an App user 200. This may include any of the above described users including hospital affiliated physicians and providers 120, the CEO and/or hospital administration 225, and the like. The toll free support number gives access twenty-four hours a day, seven days a week for technical support issues. Support issues can range from glitches involving the App or with implementing the software in a particular area. Alternatively, the App support 240 offers an online training and support site 230. This site includes a “user's manual” for troubleshooting the most frequently occurring problems as well as finding any sort of technical assistance. If the user cannot remedy the issue simply by accessing the site, there may be technical support individuals online to field support questions in real time. This is not only necessary, but critical to have the proper functioning equipment and understanding of the system and the equipment.

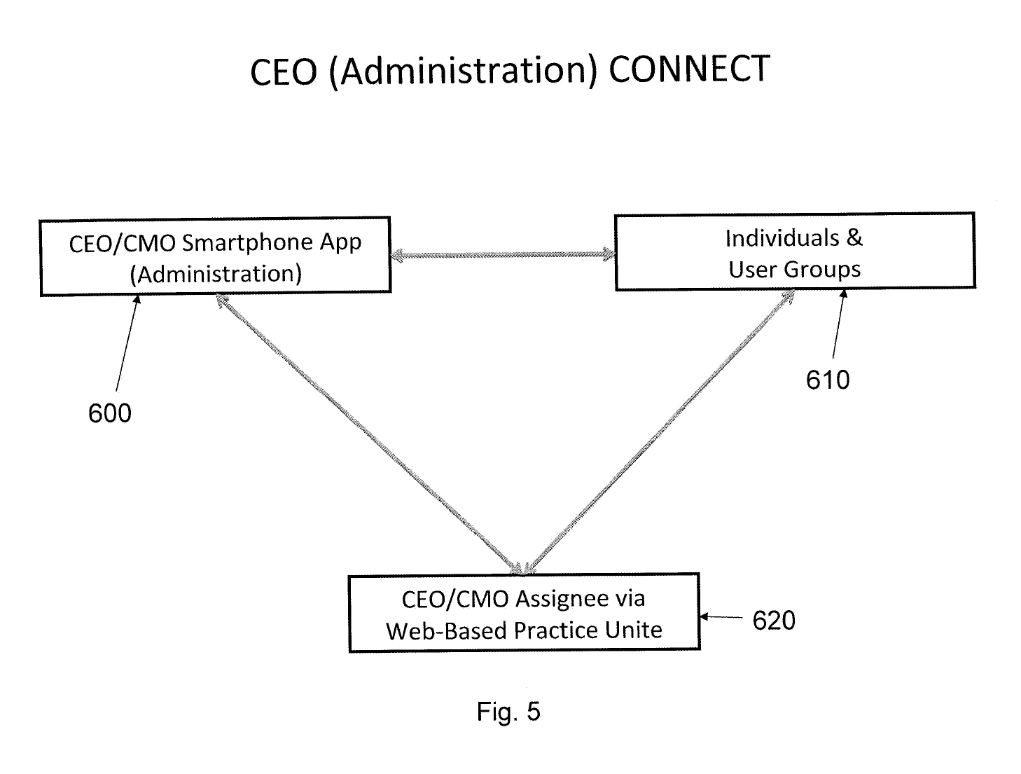

Referring to FIG. 5, there is a diagram showing the administrative connection within a management system. The three elements are interrelated and provide for communications from each member. The individuals and user groups 610, CEO/CMO (Chief Medical Officer) of the smartphone App 600, and the CEO/CMO assignee via the web-based management system 620 are all related and in communication with one another. This forms the backbone of the controlled communications management system.

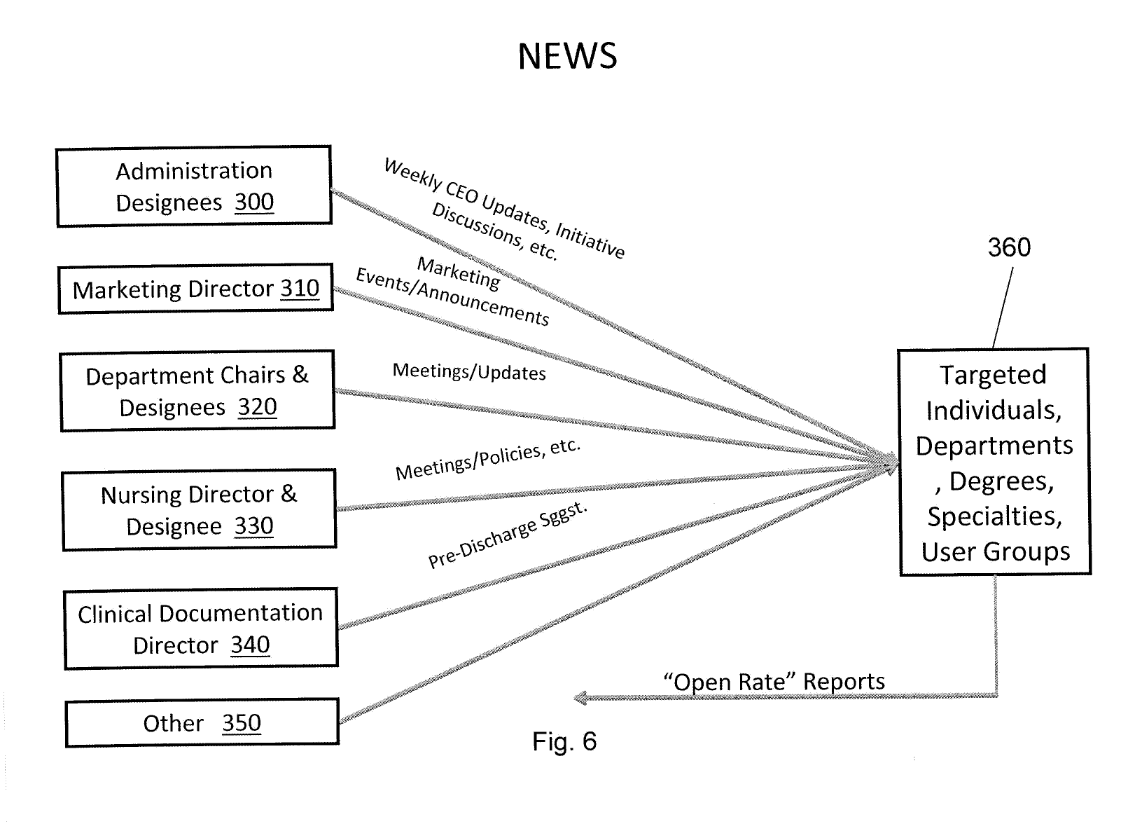

According to FIG. 6, the App system can provide a variety of others with access to news that is targeted to individuals or groups, and is pertinent to a particular job description. In order to receive such news updates, one must first be a member of the healthcare management system 195 or one of its referring members. There are a number of individuals such as administration designees 300, marketing directors 310, department chairs 320, nursing directors 330, clinical documentation directors 340, and other groups not specifically mentioned 350. These real time news blasts can be sent to targeted users, departments, or groups 360. There are examples of each type of news that may be pertinent for a particular group or individual to send and receive. For example, the marketing director 310 may be able to send out a news alert to the various individuals of the marketing department to announce various events such as meetings and updates.

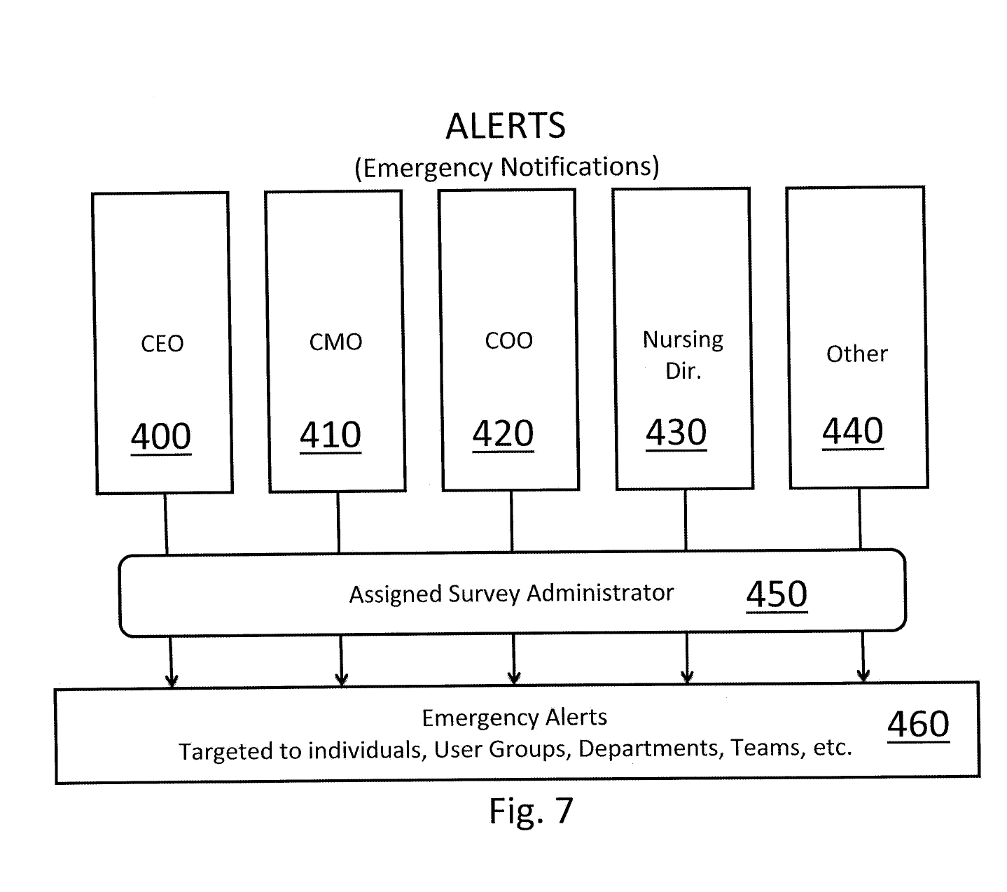

Likewise, emergency alerts can be distributed when necessary as in FIG. 7. Here, individuals such as the CEO 400, CMO 420, COO 410, Nursing Director 430, and other departmental heads or board members 440 can send out alert notifications. These notifications can take the form of a phone call, SMS, email, or other type of wired or wireless transmission. The notifications may comprise auditory, visual, tactile (vibration), or a combination of elements to alert the receiver to the presence of the emergency alert. When sent out from one of the aforementioned groups or individuals, the emergency alert first hits the various survey administrators 450. From there, the alert can be sent to the targeted individuals for whom the alert is intended 460. The alert may comprise any number of notifications or news, the importance of which rises to the level that would command such an alert.

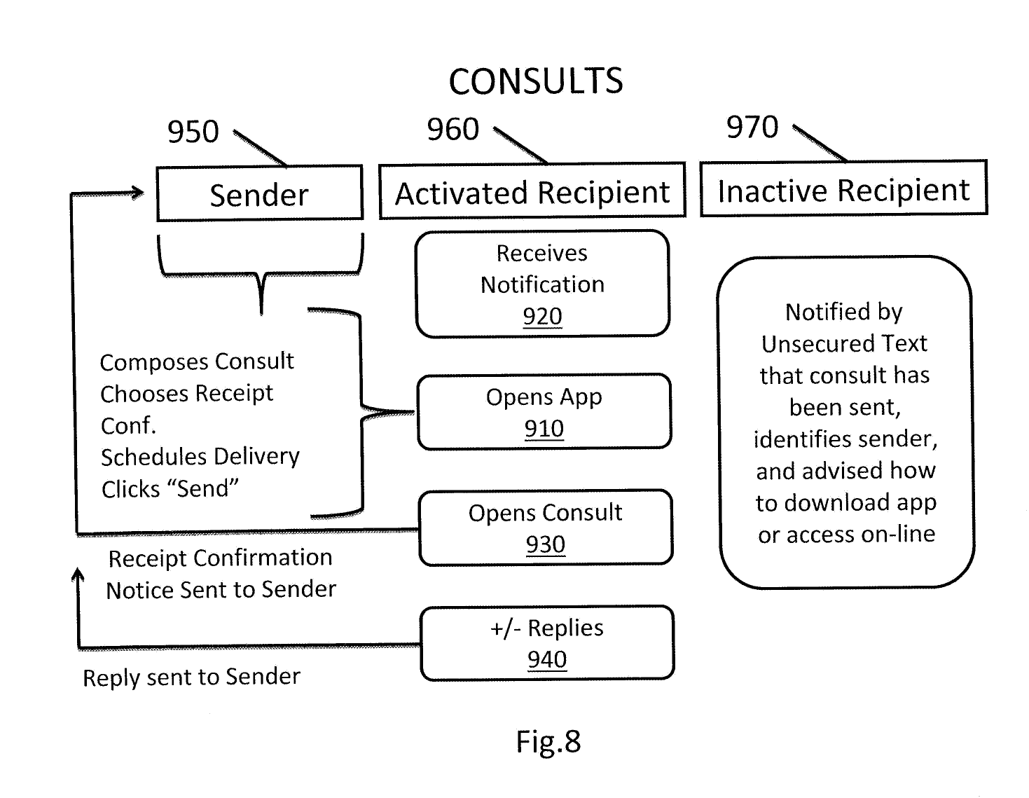

As part of the controlled, integrated digital mobile communications management system, there can be consultations scheduled for referral purposes (see FIG. 8). The sender 950 may be a physician or nurse seeking to refer a patient to another physician or nurse with a particular needed skill set or a particular specialty. The sender 950 opens the “Consult” section of the App and from there selects the person and time parameters for sending the message. The message can then, be received differently according to the type of user; those who have activated the App and those who have not activated the App (Activated recipients 960 or Inactive recipients 970). Activated recipients 960 are those who have completed the App's activation process by logging-in. They receive the consult or secure message on their mobile device. The activated recipient will receive a notification that a consult has been sent to them by someone in the management system 920. The activated recipient 960 can then open the App 910 in order to view the consult 930. There may be a message or alert to the consult on the main interface that will allow direct linkage to the consult. There may also be a main interface and the activated recipient 960 will have to then open the consult menu. Regardless of the means, once the consult request has been opened a confirmation will be sent to the sender 950 to alert them to the consult being opened or viewed. After reading the consult, the activated recipient 960 can then choose to either accept or reject the consult 940. If accepted, the consult will then be placed into the App's calendar and viewable for others. If rejected, the sender 950 will be able to resend to another individual for acceptance. In some cases, the activated recipient 960 may be able to forward on a consultation rejection to someone better suited to handle it, or to a covering physician

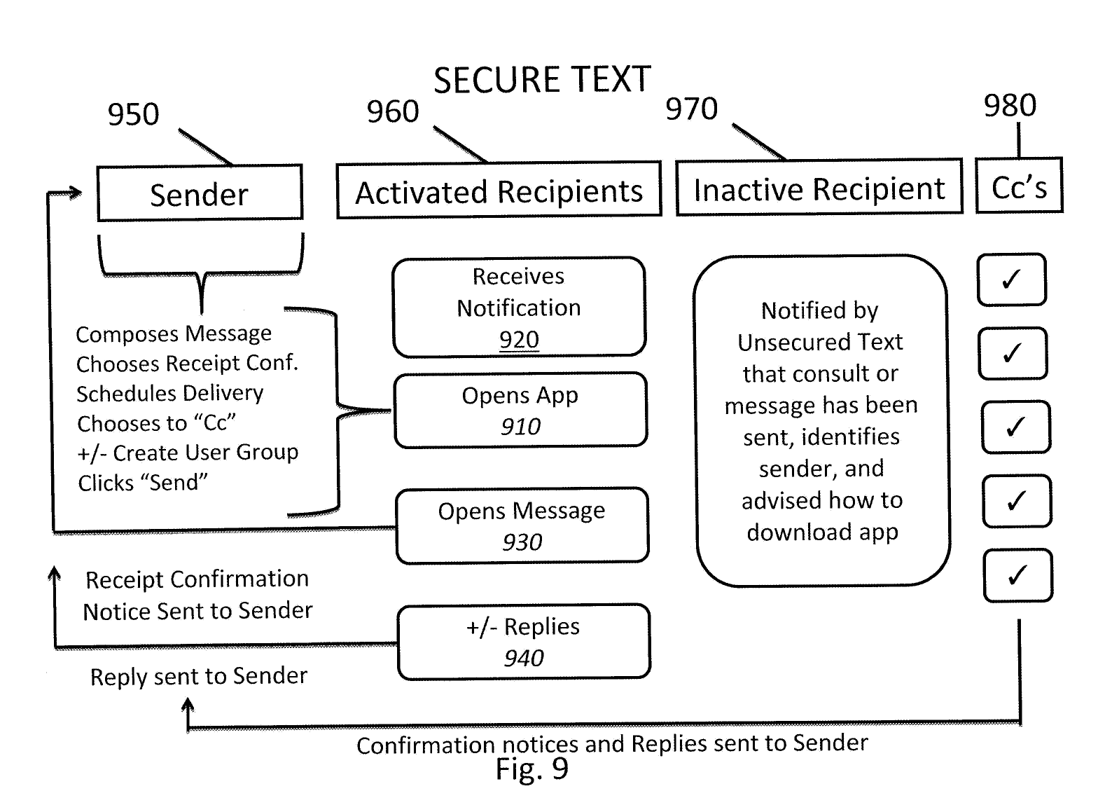

Inactive recipients 960 are those who are listed in the App but who have not yet logged-in. The Inactivated recipient 970 will be notified by an unsecured text or similar messaging medium that a consult or secure message has been sent to them. They can then access the consult or message by following directions to download and activate the App, or be advised that, alternatively, they can access the consult or message through a secure web-based version of the App. As previously described and demonstrated by FIG. 9, the messages between members of the digital, integrated mobile communications management system are all done with encrypted messaging to ensure the utmost protection to the clientele.

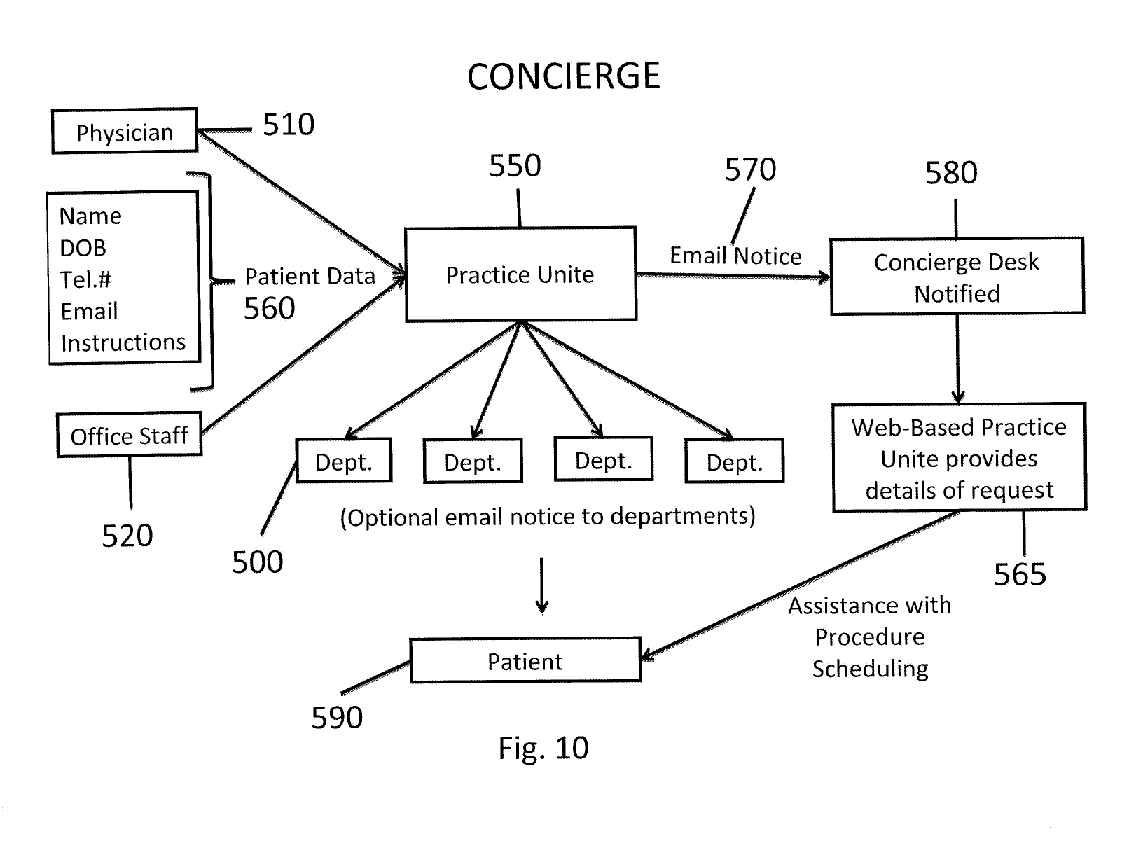

Referring to FIG. 10, not only does the controlled, integrated digital mobile communications management system provide assistance to physicians, nurses, and other providers for referrals and scheduling, but also does the same for patients through a concierge (Schedule Procedure) service. The physicians 510 or office staff 520 can input patient data into the management system for easy scheduling of appointments with specific doctors or hospitals in order to best meet patients' needs. Pertinent patient information may include name, date of birth (DOB), telephone number, address, email, any necessary instructions, and patient history. The data available for input could be greatly more extensive and may vary depending on the type of case or the location or practice of the healthcare system 195 for which the management system is employed. This data 560 is forwarded to the App (Practice Unite system) 550. From there, several actions can occur including emails being sent from the App servers to the various departments in the healthcare system 195 that may be able to contact the patient directly in order to help him/her seek the care they need. Simultaneously, an email notice 570 is sent to the concierge desk 580. The concierge desk 580 will be notified of the entry of the patient's data 560 into the management system. They can then access the details of the request, patient information, and the like through the web-based version of the App 565. Once accessed, the concierge desk will be able to contact the patient directly 590 to verify the best time to schedule an appointment and where the appointment should be scheduled.

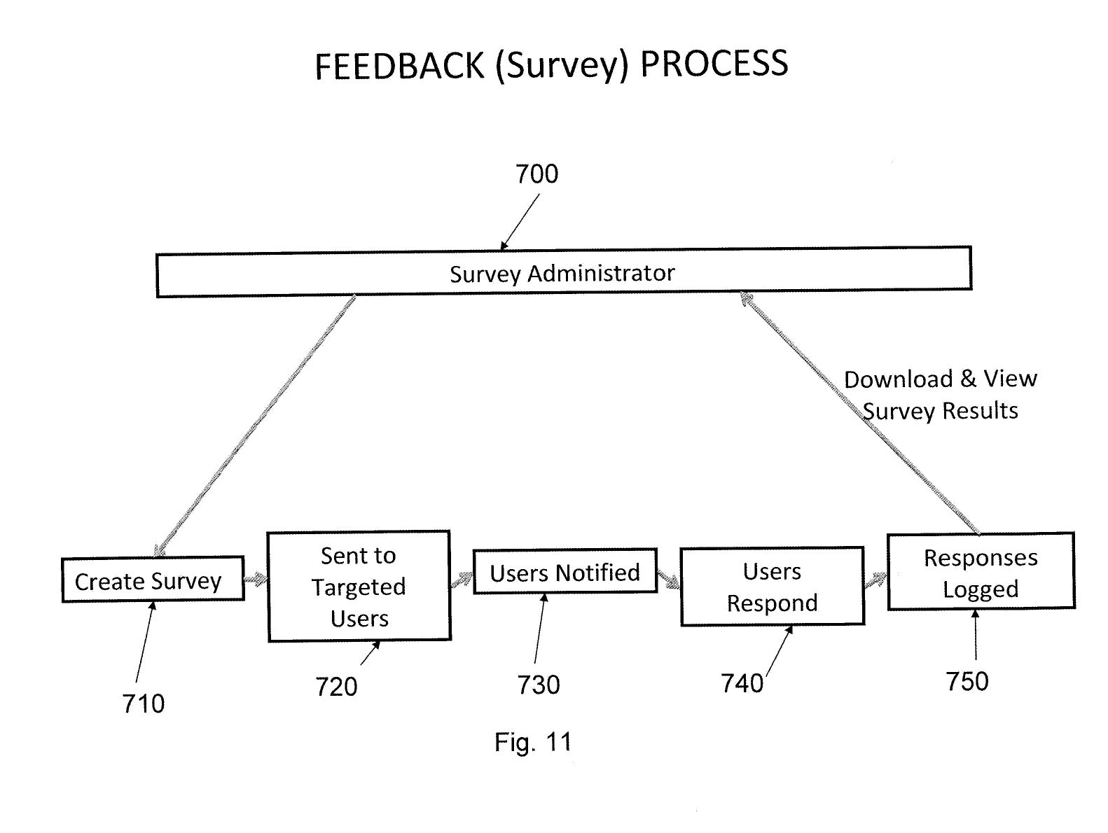

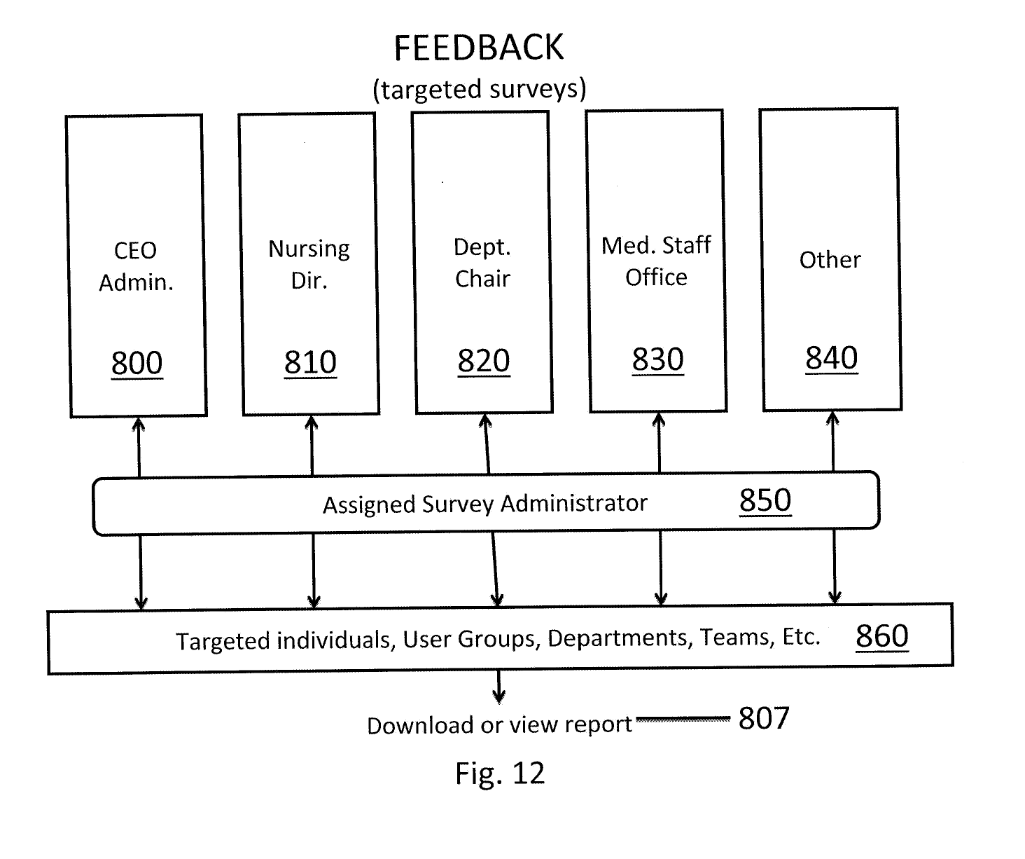

An integral part of the controlled, integrated digital mobile communications management system is the ability to fine tune the system to continually meet and rise above the needs and expectations of those associated with the management system. In FIG. 11, there is a survey process described in order to help meet these goals. It is the job of the survey administrator 700 to create surveys 710 that will give a representative idea of what is working and what needs fixing within the healthcare system. The survey administrator 700 may be assigned to a particular department or a particular location within the healthcare system. After creating a survey 710, the survey is approved and sent out to the targeted users 720. The targeted users can be any of the aforementioned individuals associated with the management system including physicians, nurses, and patients. The surveys are tailored to the individual recipients experiences with the App and the management system. This ensures that the responses will be adequate and reliable. The users will be notified 730 of the survey present. It may be preferential to give the user an incentive to complete the survey. The users' responses 740 to the survey are logged 750 within the management system. The survey administrator 700 can then log in and view the survey results, the “open rate”, and a list of individuals who have responded to the survey . . . The survey administrator 700 will tabulate and periodically distribute the survey results. The results may be distributed in paper or electronic form and sent throughout the management system (see FIG. 12). The survey administrator 700, in distributing the surveys, will assign surveys to various other survey administrators composing various departments or locations 850. They are wholly responsible for directing the surveys to the targeted individuals or groups 860. They must also direct the survey to the appropriate supervisory members such as the CEO 800, Nursing Director 810, Department Chairs 820, Medical Staff Office 830, or any other positions not mentioned 840. This survey process ensures that the results are as accurate and thorough as can be.

The controlled, integrated digital mobile communications management system of the present invention may have further functions such as, but not limited to, locating physician/providers and/or their mobile smart-devices 115, assisting in audits of mobile smart-devices, and in dealing with the theft of loss of mobile smart-devices by methods such as, but not limited to, sending instructions from a central controller to lock a mobile smart-device, or to remove a user from the system, or requiring that further use of a device may require first reporting to a particular administrator along with the device.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed:

1. A controlled, integrated mobile digital communications management system, comprising:
machine executable instructions to enable a mobile digital smart-device to perform functions comprising:
verifying a user identity of an authorized user of said mobile smart-device;
securely encrypting an electronic message regarding a patient having a patient identity prior to transmitting said electronic message to an identified recipient(s) or electronic medical record;
receiving an electronic confirmation of receipt from said identified recipient or electronic medical record;
tagging said electronic message with information comprising said user identity, said patient identity and said electronic confirmation of receipt; and
storing said tagged electronic message in a patient's electronic medical record and in a secure digital storage unit operated by a healthcare system.

2. The controlled, mobile digital communications management system of claim 1, further comprising machine executable instructions to enable said mobile digital smart-device to perform functions comprising:
receiving an encrypted electronic message;
decrypting said electronic message; and
transmitting said electronic confirmation of receipt.

3. The controlled mobile digital communications management system of claim 2, further comprising machine executable instructions to enable said mobile smart-device to perform functions comprising:
automatically associating said tagged electronic message with a designated record set associated with said identified patient.

4. The controlled mobile digital communications management system of claim 3 wherein said encrypted electronic message is HIPAA compliant.

5. The controlled mobile digital communications management system of claim 3 wherein said encrypted electronic message comprises a referral of said identified patient by said authorized user to a healthcare system operated facility.

6. The mobile digital controlled communications management system of claim 3 wherein said encrypted electronic message comprises a referral of said identified patient by said authorized user to a healthcare system recognized physician/provider.

7. The mobile digital controlled communications management software application of claim 3, further comprising machine executable instructions to enable said mobile smart-device to perform functions comprising:
specifying a specific period of time that may elapse from the transmission of said message until said mobile smart device is alerted to opening of said electronic message by an intended recipient.

8. The mobile digital controlled communications management software application of claim 3 wherein said encrypted electronic message is a patient procedure-scheduling request.

9. The mobile digital controlled communications management system of claim 3 wherein said encrypted electronic message is an alert or a request for instant help to be sent to a particular individual or group within a hospital system.

10. The mobile digital controlled communications management system of claim 3 wherein said encrypted electronic message is a communication from a first hospital personnel or physician/provider to a second hospital personnel or physician/provider, and to and from a healthcare system EMR, its nurses and staff and a physician/provider.

11. The mobile digital controlled communications management system of claim 3, further comprising:
machine executable instructions to enable a mobile digital smart-device to perform functions comprising: receiving instructions from a central controller to lock said mobile smart-device.

12. The mobile digital controlled communications management system of claim 3 wherein said encrypted electronic message is a continuing medical education video or text.

13. The mobile digital controlled communications management system of claim 12 wherein said continuing medical education video is delivered to a specific display device.

14. The mobile digital controlled communications management system of claim 3 wherein said encrypted electronic message comprises lists of “on-call” physicians/providers, “Patient Lists” for teams of physicians/providers, and a centralized healthcare system calendar function.

15. The mobile digital controlled communications management system of claim 3 wherein said encrypted electronic message delivers physician/provider performance data, along with a choice of actions that the physician/provider can take to improve his/her performance.

16. The mobile digital controlled communications management system of claim 3 wherein the type of communication received and information displayed is customizable.
